(19) United States
(12) Patent Application Publication
(10) Pub. No.: US 2012/0052161 A1
(43) Pub. Date: Mar. 1, 2012

(54) Bag With Refastenable Foldover Closure And Pour Spout

(75) Inventor: L. Roseann Woodham, Easley, SC (US)

(73) Assignee: Graphic Packaging International, Inc., Marietta, GA (US)

(21) Appl. No.: 13/223,515

(22) Filed: Sep. 1, 2011

Related U.S. Application Data
(60) Provisional application No. 61/379,086, filed on Sep. 1, 2010.

(51) Int. Cl. B65D 33/24; A23K 1/00; B65B 1/04; B65B 7/08; B65D 30/10; B65D 33/38

(52) U.S. Cl. 426/106; 383/33; 383/85; 383/86; 383/120; 383/203; 53/469

(57) ABSTRACT

A bag may include first, second, and side walls that each extend from a bottom wall of the bag to an upper end of the bag. The bag may also include a reusable fastener including a first fastener part mounted to the first wall and a second fastener part mounted to the second wall. The releasable fastener may be a hook-and-loop fastener, which may continue to function when exposed to particulate matter of the product. The upper end may be configurable between a first closed configuration wherein the first wall is secured to the second wall, a second closed configuration wherein the first fastener part is fastened to the second fastener part, and an open configuration wherein the first wall is at least partially separated from the second wall. In the open configuration, a pour spout may be formed in side upper marginal portion of the bag.

### CROSS-REFERENCE TO RELATED APPLICATION

This application claims the benefit of U.S. Provisional Patent Application No. 61/379,086, which was filed on Sep. 1, 2010. The entire disclosure of U.S. Provisional Patent Application No. 61/379,086, which was filed on Sep. 1, 2010, is incorporated herein by reference.

### TECHNICAL FIELD

This disclosure relates to reclosable bags.

### BACKGROUND

It is known to reclose a bag, such as by using a reusable pressure sensitive adhesive that is designed to repeatedly stick and unstick. When fine particles are dispensed from such a bag, the fine particles may inadvertently become adhered to the reusable pressure sensitive adhesive and impair the functionality of the reusable pressure sensitive adhesive.

There is always a desire for a reclosable bag that provides a new balance of properties.

### BRIEF SUMMARY OF SOME ASPECTS OF THIS DISCLOSURE

In accordance with one aspect of this disclosure, a bag has an upper end that may be closed by at least one fastener (e.g., a mechanical fastener such as, but not limited to, a hook and loop fastener) that includes front and rear fastener parts that may be respectively mounted to front and rear walls of the bag. In accordance with an exemplary embodiment, the upper end of the bag may be closed in different configurations. For example, the closure at the upper end of the bag may be:
a single foldover closure comprising a substantially tubular upper end of the bag being in a single foldover configuration that may be secured by way of at least one seal (e.g., the substantially tubular upper end of the bag being sealed/secured (e.g., adhered) to itself), or
a double foldover closure comprising the substantially tubular upper end of the bag being in a double foldover configuration that may be secured solely by the front and rear fastener parts (e.g., the hook and loop fastener(s)), or that may be secured by both the at least one seal and the front and rear fastener parts.
   The double foldover configuration typically includes the single foldover configuration, and the double foldover configuration may be at least partially secured by the at least one seal and/or the front and rear fastener parts.

In one example of a method of use, the bag initially contains contents and the upper end of the bag is in the single foldover configuration that is secured by the at least one seal (e.g., the substantially tubular upper end of the bag is secured (e.g., adhered) to itself). Then, the at least one seal is undone and the upper end of the bag is at least partially opened to dispense at least some of the contents of the bag. Then, the upper end of the bag is configured in the double foldover configuration, and the double foldover configuration may be secured solely by the front and rear fastener parts being mated to one another (e.g., the double foldover configuration is secured by the hook and loop fastener(s)).

The bag in and of itself may be, for example, a self opening sack (“SOS”), or a square or block bottom bag.

By way of further example, in one embodiment a packaged product assembly is provided.

The packaged product assembly may comprise a product (e.g., pet food) comprising a particulate matter and a container, which may be in the form of a bag, that contains the product. The bag may comprise a first wall and a second wall connected by a plurality of side walls and a bottom wall, wherein the first wall, the second wall, and the side walls extend from the bottom wall to an upper end. The bag may further include a reusable fastener comprising a first fastener part mounted to the first wall and a second fastener part mounted to the second wall, wherein one of the first fastener part and the second fastener part comprises a hooked material and one of the first fastener part and the second fastener part comprises a looped material. The upper end may be configurable between a first closed configuration wherein the first wall is secured to the second wall, a second closed configuration wherein the first fastener part is fastened to the second fastener part, and an at least partially open configuration wherein the first wall is at least partially separated from the second wall.

In an additional embodiment a method for forming a packaged product assembly is provided. The method may include having (e.g., providing) a container, which may be in the form of a bag. For example, the bag may comprise the bag of the packaged product assembly, including first, second, and side walls extending from a bottom wall to an upper end, as described above. In this regard, in one embodiment the bag may be provided without an associated product contained therein. The method may further comprise configuring the upper end to an open configuration wherein the first wall is at least partially separated from the second wall and at least partially filling the bag with a product comprising a particulate matter. Further, the method may include configuring the upper end to a first closed configuration wherein the first wall is secured to the second wall, and configuring the upper end to a second closed configuration wherein the first fastener part is fastened to the second fastener part. In some embodiments, the configuring of the upper end to the first closed configuration may comprise folding the first wall and the second wall at a lateral fold line. Further, in some embodiments, the configuring of the upper end to the second closed configuration may comprise folding the first wall and the second wall at a second lateral fold line.

Various embodiments of the bag, which as noted above may be employed in the packaged product assembly and/or one or more methods, are provided. For example, in some embodiments the side walls may comprise a plurality of side pleats formed by a plurality of lines of disruption. The side pleats may be folded inwardly in the first closed configuration. Further, the side pleats may respectively comprise a plurality of outer portions, and the outer portions of the side pleats may be respectively sealed to one another in the first closed configuration. Additionally, the side pleats may respectively comprise a plurality of inner portions, and each of the inner portions may be respectively sealed to one of the first wall and the second wall in the first closed configuration. In some embodiments, the first wall may be secured to the second wall by a single use seal in the first closed configuration. Further, the first wall and the second wall may be folded at a lateral fold line in the first closed configuration. A first outer portion of the first wall may be in opposing face-to-face contact with a second outer portion of the first wall in the first closed configuration. In the second closed configuration, the first wall and the second wall may be folded at the lateral fold line and at a second lateral fold line. In the open configuration, a distance between the first fastener and the upper end may be greater than a distance between the second fastener and the upper end. The first wall, the second wall, the side walls, and the bottom wall may comprise at least one of a paper material and a polymer film.

The at least partially open configuration of the upper end of the bag may simultaneously comprise a pour spout being defined by a first upper marginal portion of the bag, and a second upper marginal portion of the bag being at least partially closed, wherein the first and second upper marginal portions of the bag are positioned at opposite sides of the bag. One or more disruptions, such as tear lines, may be include in the upper margin of the bag for at least partially facilitating formation of the pour spout. The fastener parts may be configured relative to the disruptions for aiding in closing the pour spout, such as by holding the upper end of the bag in the double foldover configuration.

Other aspects and advantages of the present invention will become apparent from the following.

### BRIEF DESCRIPTION OF THE DRAWINGS

In the following, reference is made to the accompanying drawings, which are schematic and are not necessarily drawn to scale, and wherein:

FIG. 1 is a side, front pictorial view of a bag with its upper end open, in accordance with a first embodiment of this disclosure.

FIG. 2 is a side, rear pictorial view of the bag of FIG. 1 with its upper end open.

FIG. 3 is a cut-away, front elevation view of an upper portion of the bag of FIG. 1 in a flattened configuration and with its side pleats folded outwardly.

FIG. 4 is a cut-away, rear elevation view of the upper portion of the bag of FIG. 3.

FIG. 5 is a cut-away, top pictorial view of the interior of the upper portion of the bag of FIG. 1 in an open configuration, with the side pleats folded inwardly.

FIG. 6 is a side, front pictorial view of the bag of FIG. 1 with its upper end in a first closed configuration (i.e., a single foldover configuration).

FIG. 7 is a front pictorial view of the bag of FIG. 1 with its upper end in the first closed configuration.

FIG. 8 is a side, front pictorial view of the bag of FIG. 1 with its upper end in a second closed configuration (i.e., a double foldover configuration).

FIG. 9 is a front pictorial view of a bag of with its upper end in a first closed configuration (i.e., a single foldover configuration), in accordance with a second embodiment of this disclosure.

FIG. 10 is a side, front pictorial view of a bag with its upper end fully open, in accordance with a fourth embodiment of this disclosure.

FIG. 11 is a side, rear pictorial view of the bag of FIG. 10 with its upper end fully open.

FIG. 12 is a cut-away, front elevation view of an upper portion of the bag of FIG. 10 in a flattened configuration and with its side pleats folded outwardly.

FIG. 13 is a cut-away, rear elevation view of the upper portion of the bag of FIG. 12.

FIG. 14 is a cut-away, top pictorial view of the interior of the upper portion of the bag of FIG. 10 in a fully open configuration, with the side pleats folded inwardly.

FIG. 15 is a side, front pictorial view of the bag of FIG. 10 with its upper end in a first closed configuration (i.e., a single foldover configuration).

FIG. 16 is a front pictorial view of the bag of FIG. 10 with its upper end in a partially open configuration.

FIG. 17 is a side, front pictorial view of the bag of FIG. 10 with its upper end partially open and configured as a spout.

FIG. 18 is a side, front pictorial view of the bag of FIG. 10 with its upper end in a second closed configuration (i.e., a double foldover configuration).

### DETAILED DESCRIPTION

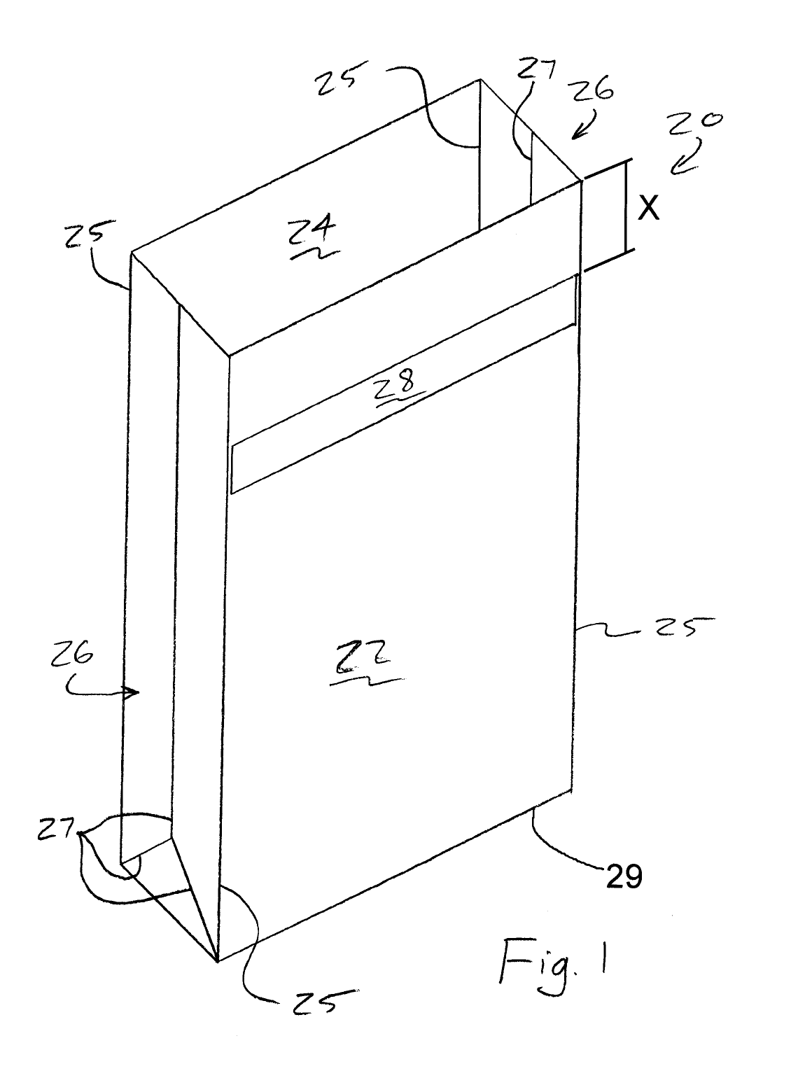

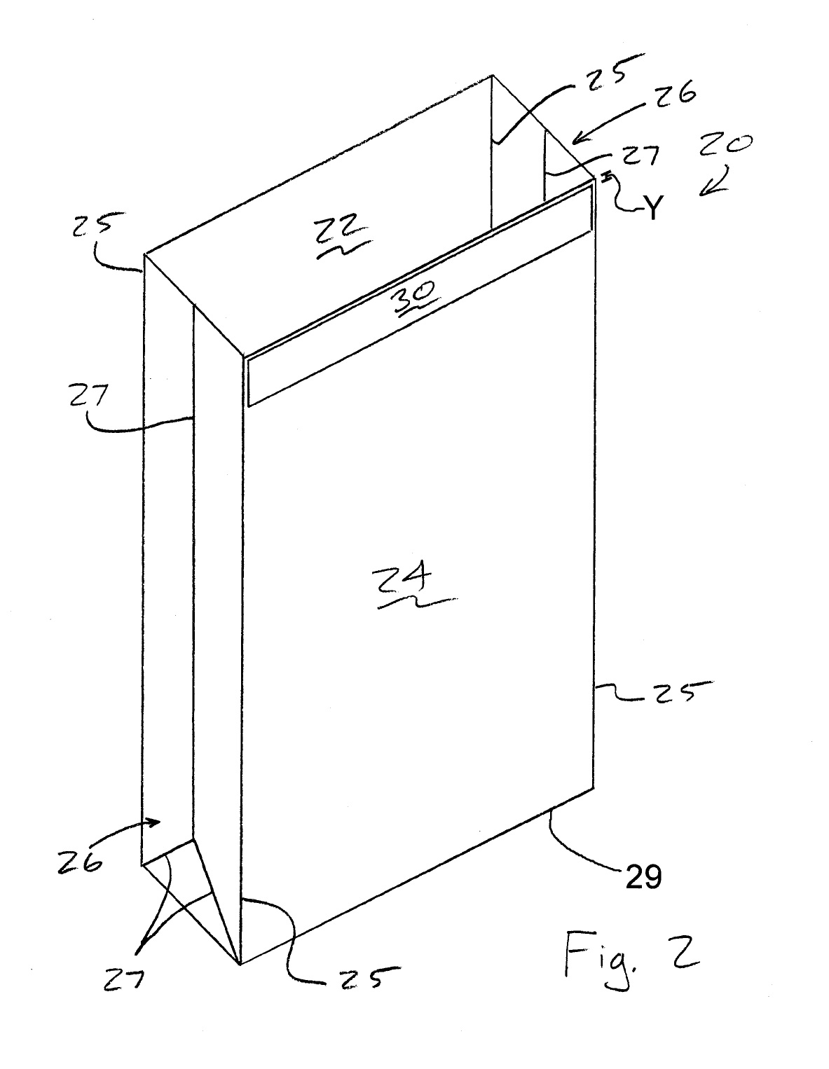

Referring now in greater detail to the drawings, in which like numerals refer to like parts throughout the several views, exemplary embodiments are described in the following. A container, or more specifically a bag 20, of a first embodiment is shown in FIGS. 1 and 2, with its upper end open, and its lower end closed. The bags disclosed herein may be configured and employed to hold one or more of a variety of products. In one embodiment the bags disclosed herein may be configured and employed to contain a product comprising particulate matter. For example, the bags may be configured to store cat or dog food or other pet food, which may comprise a degree of particulate matter.

The bag 20 in and of itself is of the type that is commonly referred to as a self opening sack (“SOS”), or a square or block bottom bag, although different types of bags are within the scope of this disclosure (e.g., the bag 20 in and of itself may be any suitable type of bag). Those of ordinary skill in the art will be able to form the conventional closed lower end of the bag 20 so that it is in the form of an SOS or square or block bottom bag. More generally, the bottom of the bag 20 may be closed in any suitable manner, such as with a foldover seal, fin seal, or any other suitable seal.

The bag 20 includes front and rear walls 22, 24 that are connected by side walls. The front and rear walls 22, 24 are typically connected to the side walls by longitudinal lines of disruption 25 (e.g., fold lines). The side walls may optionally comprise/be in the form of side pleats 26. The side pleats 26 are formed by longitudinal and oblique lines of disruption 27 (e.g., fold lines).

A reusable fastener is mounted to the bag 20. In the first embodiment, the reusable fastener is a mechanical fastener that is more specifically in the form of a conventional hook-and-loop fastener, such as a Velcro brand hook-and-loop fastener. The hook-and-loop fastener may be advantageously employed in embodiments of the bag 20 configured to contain a product comprising particulate matter. For example, the bags may be configured to store pet food, which may comprise particulate matter. In this regard, hook-and-loop fasteners may retain the ability to attach to one another (e.g., a hooked portion may still be able to engage a looped portion) when exposed to particulate matter. In contrast, other reusable closure mechanism may be detrimentally affected by exposure to particulate matter. For example particulate matter may stick to adhesives so as to prevent or impede attachment to another surface. Further, zippers and interlocking groove and ridge seals may be unable to completely close when subjected to particulate matter. Accordingly, hook-and-loop fasteners may provide substantial benefits over other embodiments of reusable fasteners when employed to close bags containing a product comprising at least some particulate matter.

The reusable fastener of the present disclosure may include front and rear fastener parts 28, 30 respectively mounted to the front and rear walls 22, 24 of the bag 20. In the first embodiment, the front fastener part 28 is a strip of looped material of the conventional hook-and-loop fastener, and the rear fastener part 30 is a strip of hooked material of the conventional hook-and-loop fastener, although the strips of hooked and looped material may be interchanged. The strip-like front and rear fastener parts 28, 30 may extend laterally substantially all the way across the front and rear walls 22, 24, respectively. A variety of different types, sizes and arrangements of the fastener parts 28, 30 are within the scope of this disclosure.

The fastener parts 28, 30 may be mounted to the bag 20, or a precursor of the bag, in any suitable manner. As one example, the fastener parts 28, 30 may have an adhesive backing, and the fastener parts may be mounted to the bag 20, or a precursor of the bag, in a manner similar to that in which adhesive-backed labels are mounted to bags or precursors of bags. Alternatively, patches of adhesive material may be mounted to the bag 20, or a precursor of the bag, and then the fastener parts 28, 30 may respectively be mounted to the patches of adhesive material. Alternatively, the fastener parts 28, 30 may be mounted to the bag 20, or a precursor of the bag, in any suitable manner.

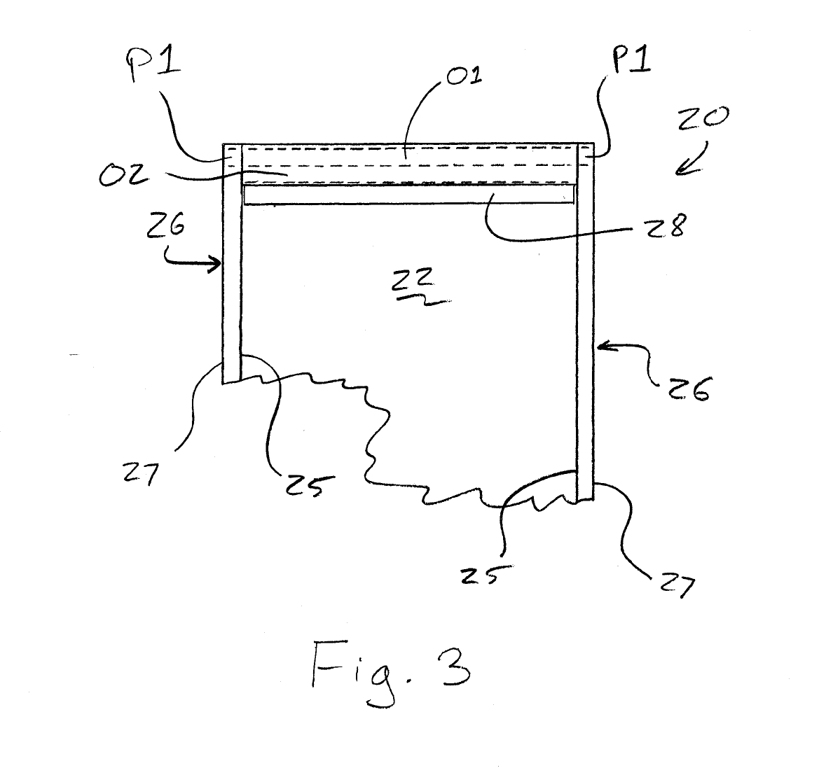

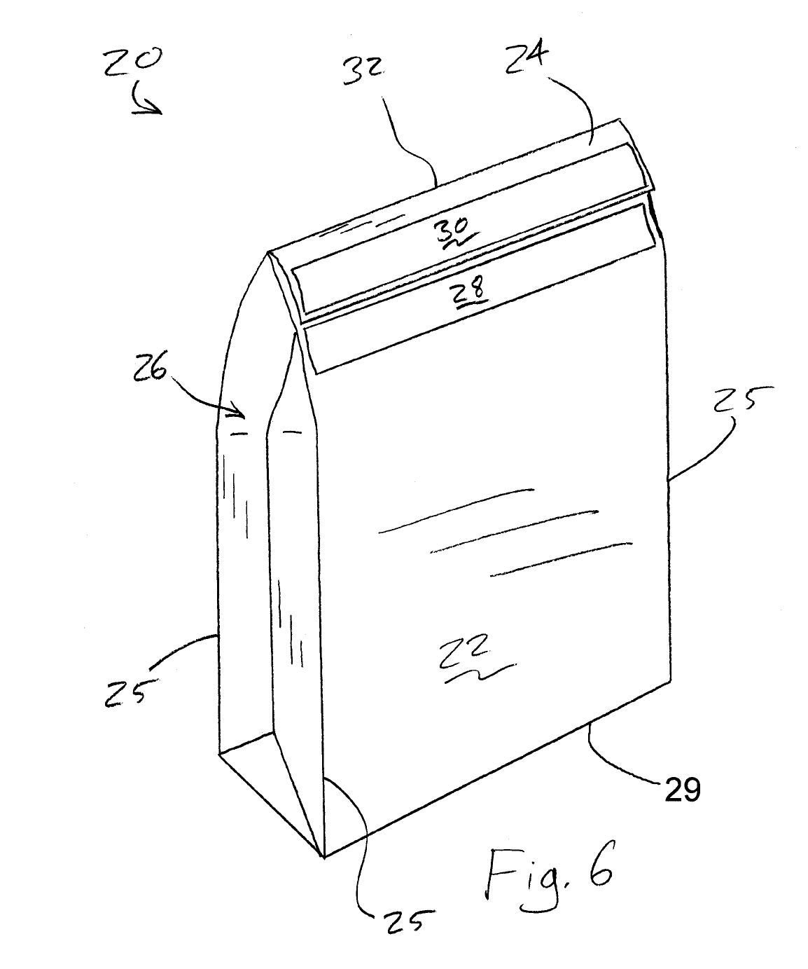

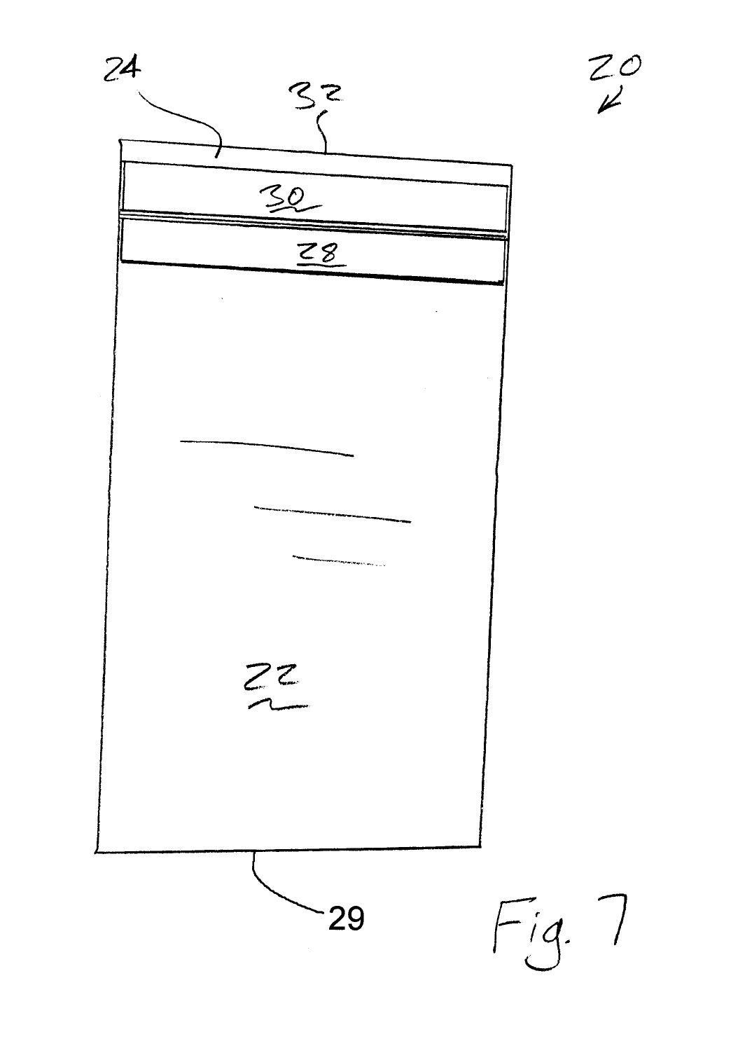

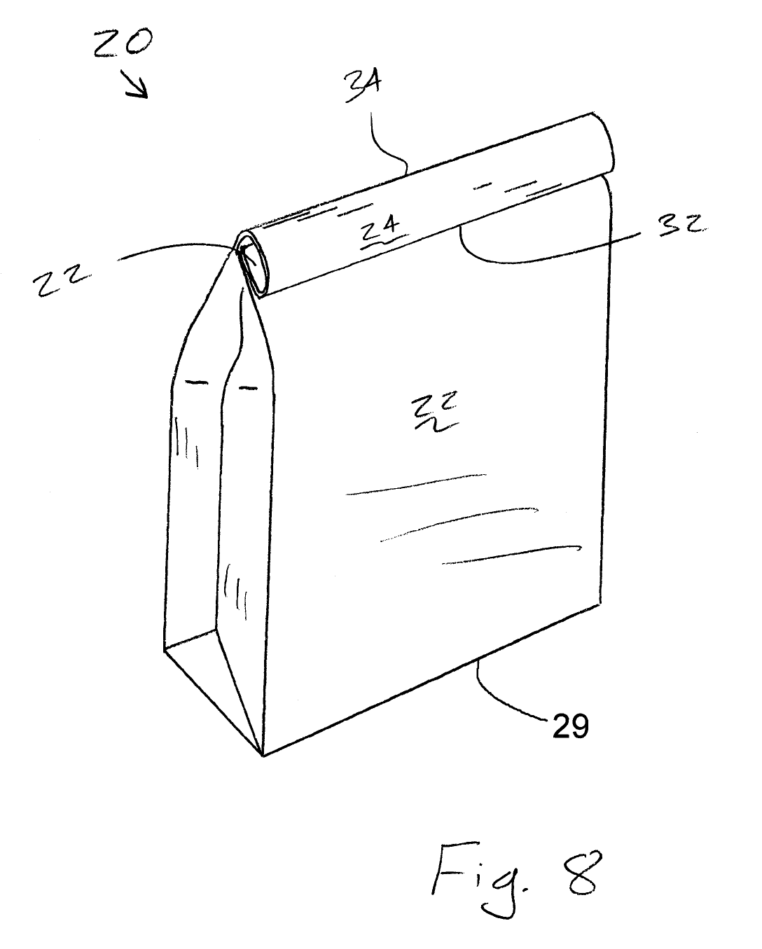

As will be discussed in greater detail below with reference to FIG. 8, the front and rear fastener parts 28, 30 may be used to releasably secure the substantially tubular top of the bag 20 in a double foldover configuration. As will also be discussed in greater detail below with reference to FIGS. 6 and 7, the substantially tubular top of the bag 20 may optionally also be secured in a single foldover configuration. FIGS. 3-5 provide background information that may be helpful in understanding the foldover configurations.

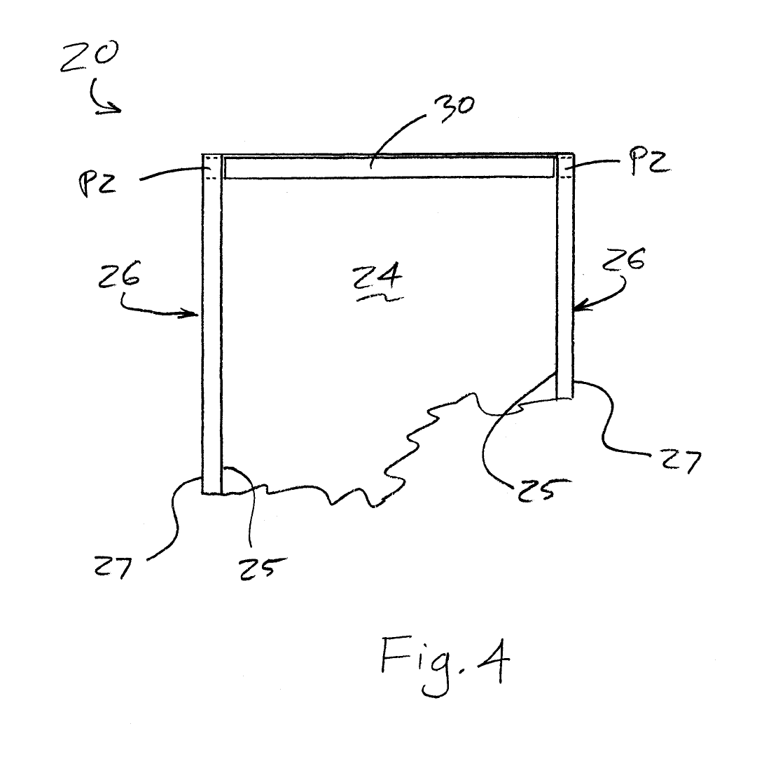

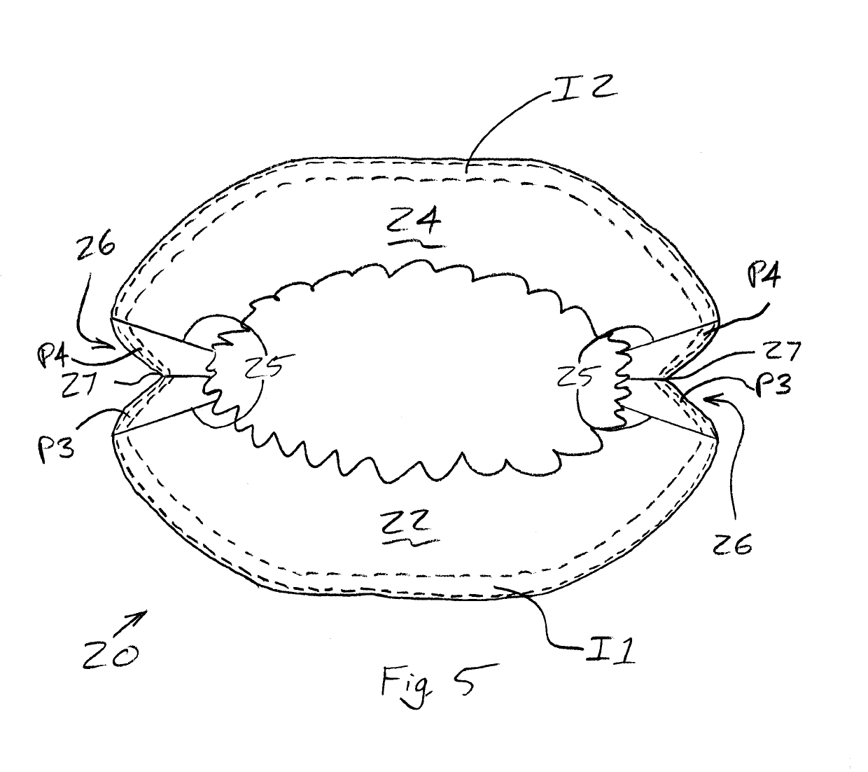

For ease of understanding, the front and rear views of FIGS. 3 and 4 show the side pleats 26 folded outwardly, although the side pleats typically remain folded inwardly, at least until after the interior of the bag 20 is partially filled with contents (e.g., pet food, or any other suitable contents, not shown). In the top pictorial view of FIG. 5, the side pleats 26 are folded inwardly. FIGS. 3 and 4 are schematic because, for example, they include dashed lines for schematically identifying that the front wall 22 of the bag 20 includes first and second portions O1, O2 of the bag, and each side pleat 26 includes surface portions P1, P2. FIG. 5 is schematic because, for example, it includes dashed lines for schematically identifying that the interior surface of the front and rear walls 22, 24 of the bag 20 include first and second inner portions I1, I2, respectively, and each side pleat 26 includes surface portions P3, P4. FIG. 5 further illustrates a bottom wall 29 of the bag 20. The bottom wall 29 may be integral with the front wall 22, the rear wall 24, and/or one or both of the side walls (e.g., integral with the pleats 26) in some embodiments, or the bottom wall may be otherwise attached thereto to define the closed lower end of the bag 20.

An example of a method of using the bag 20 is described in the following, in accordance with the first embodiment. With the bottom of the bag 20 fully formed/closed, contents are loaded into the interior of the bag 20 through its substantially tubular upper opening. Then, and as shown in FIGS. 6 and 7, the top of the bag 20 is closed by a single foldover closure, and the single foldover closure is secured with at least one seal (e.g., hermetically sealed closed). The single foldover closure includes a first lateral line of disruption 32 (e.g., fold line) about which both of the front and rear walls 22, 24 are simultaneously folded to transform the substantially tubular upper end of the bag 20 into the single foldover configuration. In accordance with the first embodiment, the combination of the single foldover closure and the at least one seal is conventional, and the at least one seal typically comprises both a pinch seal and a foldover seal.

As best understood with reference to FIGS. 3-5, in the pinch seal:
all (e.g., substantially all) of the portions of the inner portions I1, I2 (FIG. 5) that are in opposing face-to-face relation with one another are in opposing face-to-face contact with one another and are sealed to one another;
at each side pleat 26, all (e.g., substantially all) of the surface portions P1, P2 (FIGS. 3 and 4) are in opposing face-to-face contact with one another and are sealed to one another;
at each side pleat 26, all (e.g., substantially all) of the surface portion P3 (FIG. 5) and the inner portion I1 are in opposing face-to-face contact with one another and are sealed to one another; and
at each side pleat 26, all (e.g., substantially all) of the surface portion P4 (FIG. 5) and the inner portion I2 are in opposing face-to-face contact with one another and are sealed to one another.

In the foldover seal, all (e.g., substantially all) of the portions O1, O2 (FIG. 3) are in opposing face-to-face contact with one another and are sealed to one another. The at least one seal (e.g., the pinch seal and/or the foldover seal) for maintaining the top of the bag 20 in the single foldover configuration may be provided in any suitable conventional manner, such as by way of a heat sealable material, adhesive material, mechanical fasteners, or otherwise. Similarly, the fastener parts 28, 30 may be fixedly connected to the front and rear walls 22, 24 of the bag in any suitable manner, such as by way of a heat sealable material, adhesive material, mechanical fasteners, or otherwise. Adhesive material may be intervened between above-mentioned portions that are referred to as being in opposing face-to-face contact; therefore, each of those opposing face-to-face contacts may be more generally referred to as substantially opposing face-to-face contact.

When it is desired to access the contents within the bag 20, the at least one seal, which is securing the upper end of the bag in its single foldover configuration (e.g., see FIGS. 6 and 7), is typically manually undone in a conventional manner, typically without any substantial tearing of the bag, and the substantially tubular upper end of the bag 20 is opened (e.g., see FIGS. 1 and 2). The at least one seal, which is securing the upper end of the bag 20 in its single foldover configuration, is typically a single use feature that, once undone, may not be used to reseal the bag 20 in a closed configuration. For example, the at least one seal may be formed by adhesive material, but typically (e.g., optionally) the at least one seal is not formed by a reusable pressure sensitive adhesive that is designed to repeatedly stick and unstick. With the upper end of the bag 20 opened, the contents may be dispensed.

Then, the upper end of the bag 20 may be configured in the double foldover configuration shown in FIG. 8, and the bag may be releasably secured in the double foldover configuration by activating the reusable fastener (i.e., by manually pressing together the front and rear fastener parts 28, 30 so that they become releasably interlocked to one another). That is, as shown in FIG. 8, the bag 20 is configured in the double foldover configuration, and the front and rear fastener parts 28, 30 are secured to one another (i.e., releasably interlocked to one another) so that the bag is releasably maintained in the double foldover configuration. The double foldover closure includes the first lateral line of disruption 32 and a second lateral line of disruption 34 (e.g., fold line). The double foldover configuration may be achieved by first placing the substantially tubular upper end of the bag 20 in the single foldover configuration (e.g., by simultaneously folding the front and rear walls 22, 24 about the first lateral line of disruption 32), and then simultaneously folding the front and rear walls 22, 24 about the second lateral line of disruption 34. In this regard, the front fastener 28 may be separated from the upper end of the bag 20 by a distance X (see, e.g., FIG. 1) that is greater than a distance Y (see, e.g., FIG. 2) between the rear fastener 28 and the upper end of the bag. Accordingly, folding the front and rear walls 22, 24 along the first lateral line of disruption 32 toward the front wall and then folding the front and rear walls along the second lateral line of disruption 34 toward the front wall may cause the rear fastener 30 to align with the front fastener 28. Conversely, in embodiments in which the upper end of the bag 20 is configured to be folded toward the rear wall 24, the distance X between the front fastener 28 and the upper end of the bag may be less than the distance Y between the rear fastener 30 and the upper end of the bag such that the front fastener aligns with the rear fastener in the double foldover configuration.

Thereafter, when it is desired to access the contents within the bag 20, the fastener parts 28, 30 may be manually separated from one another to deactivate the reusable fastener, and then the upper end of the bag 20 may be opened, for dispensing contents from the bag. The upper end of the bag 20 may be conveniently transitioned numerous times between the open configuration (e.g., see FIGS. 1 and 2) and the configuration in which the bag is releasably secured in the double foldover configuration by the interlocked fastener parts 28, 30 (e.g., see FIG. 8).

The interior volume of the bag 20 is typically larger when the upper end of the bag is sealed in the single foldover configuration (FIGS. 6 and 7) by the at least one seal, than when the upper end of the bag is sealed in the double foldover configuration (FIG. 8) by the interlocked fastener parts 28, 30. Therefore, after the bag 20 is initially filled, it may be common for the upper end of the bag to be closed with just the single foldover closure, and for the upper end of the bag to be sealed in the single foldover configuration (FIGS. 6 and 7) solely by the at least one seal. Alternatively, after the bag 20 is initially filled, the upper end of the bag may be closed with just the pinch seal. As another alternative, after the bag 20 is initially filled, the upper end of the bag may be sealed in the double foldover configuration (FIG. 8) by both the interlocked fastener parts 28, 30 and one or more of the pinch seal and the foldover seal. The bag 20 may be initially filled by way of either its top or bottom end, although it may typically be filled by way of its top end when in the form of a SOS or a square or block bottom bag.

The bag 20 may be a single or multiwall bag constructed of any suitable material, such as, but not limited to, polymer film, paper (e.g., Kraft paper and/or clay coated paper), fabric, a laminate that includes fabric, a laminate that includes polymer film, a laminate that includes paper (e.g., Kraft paper and/or clay coated paper) and one or more polymer layers (e.g., polymer film(s) or coating(s)) such that the bag may appear to be, or may be, a polymer lined paper bag, or the like. One or more layers of the bag may be coextruded and/or otherwise joined to one another. Such layers may include polymer films, polymer or polymeric coatings or layers, paper layers, woven materials or nonwoven materials, or any other suitable material. The bag 20 may be constructed of any suitable material or materials. For example, the bag 20 may be a multi-wall (e.g., multi-ply) bag.

Reiterating from above, the bag 20 in and of itself may be any suitable type of bag. For example, the entire disclosure of U.S. patent application Ser. No. 12/776,507, which was filed May 10, 2010, and is entitled “Heat Sealing Systems and Methods, and Related Articles and Materials”, is incorporated herein by reference.

A second embodiment of this disclosure is like the first embodiment, except for variations noted and variations that will be apparent to one of ordinary skill in the art. Accordingly, some like reference numerals are used for the first and second embodiments, except that an apostrophe is added to respective reference numerals of the second embodiment.

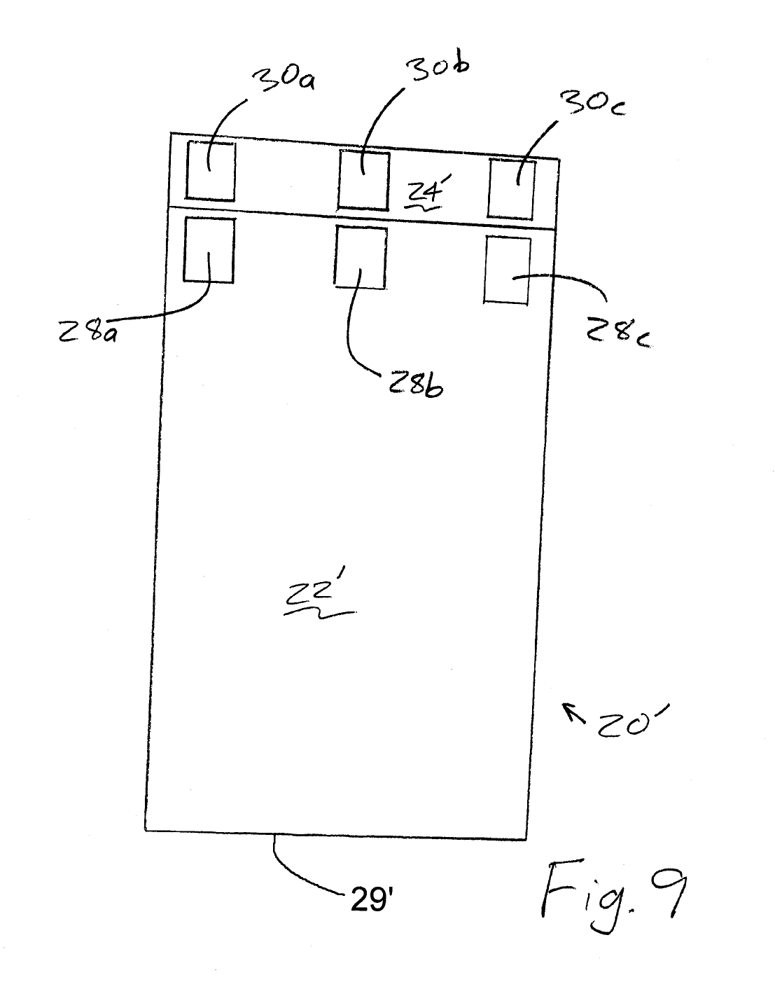

FIG. 9 is like FIG. 7, except for illustrating the bag 20′ of the second embodiment. In accordance with the second embodiment, the front and rear fastener parts 28, 30 (FIGS. 1-4, 6 and 7) of the first embodiment may each be replaced with a series of spaced apart front and rear fastener parts 28a, 28b, 28c, 30a, 30b, 30c (FIG. 7) respectively mounted to the front and rear walls 22′, 24′ of the bag 20′. Other embodiments are like the second embodiment, except that one or more mateable pairs of the front and rear fastener parts 28a, 28b, 28c, 30a, 30b, 30c may be omitted. For example, a third embodiment of this disclosure is like the second embodiment, except that fastener parts 28a, 28c, 30a, 30c are omitted.

A fourth embodiment of this disclosure is like the first embodiment, except for variations noted and variations that will be apparent to one of ordinary skill in the art. Accordingly, some like reference numerals are used for the first and fourth embodiments, except that two apostrophes are added to respective reference numerals of the fourth embodiment.

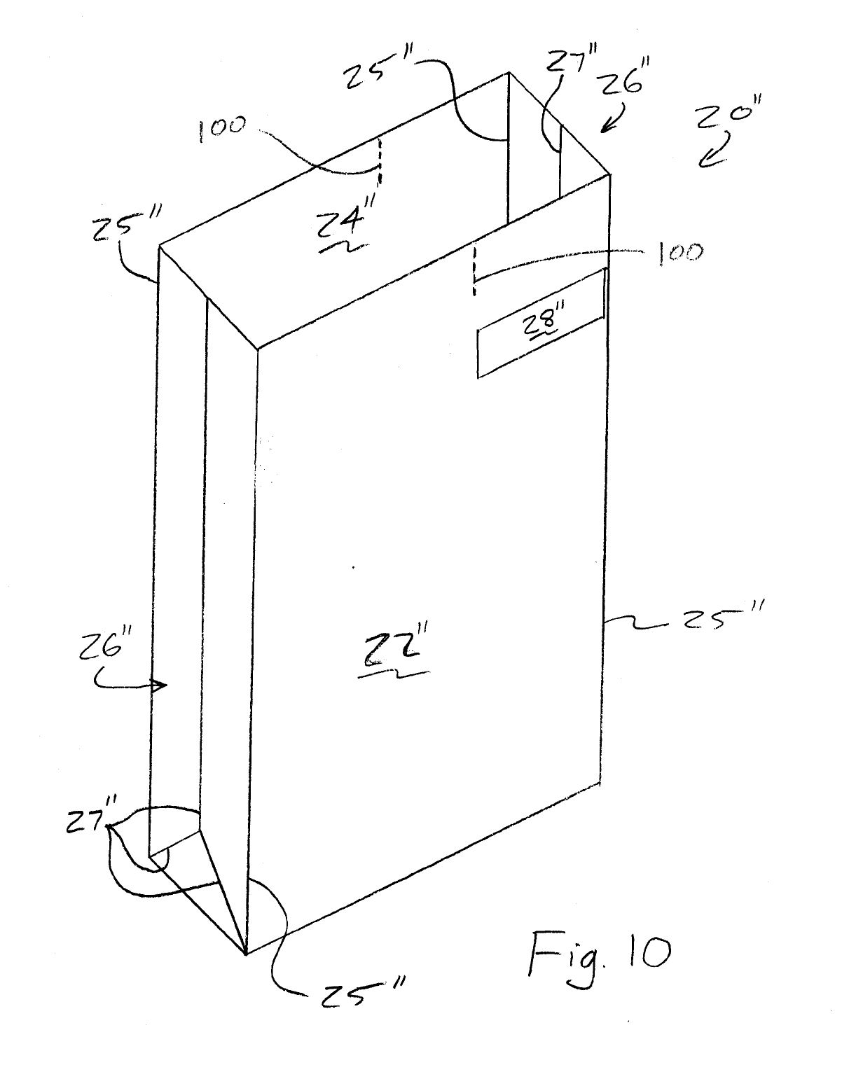

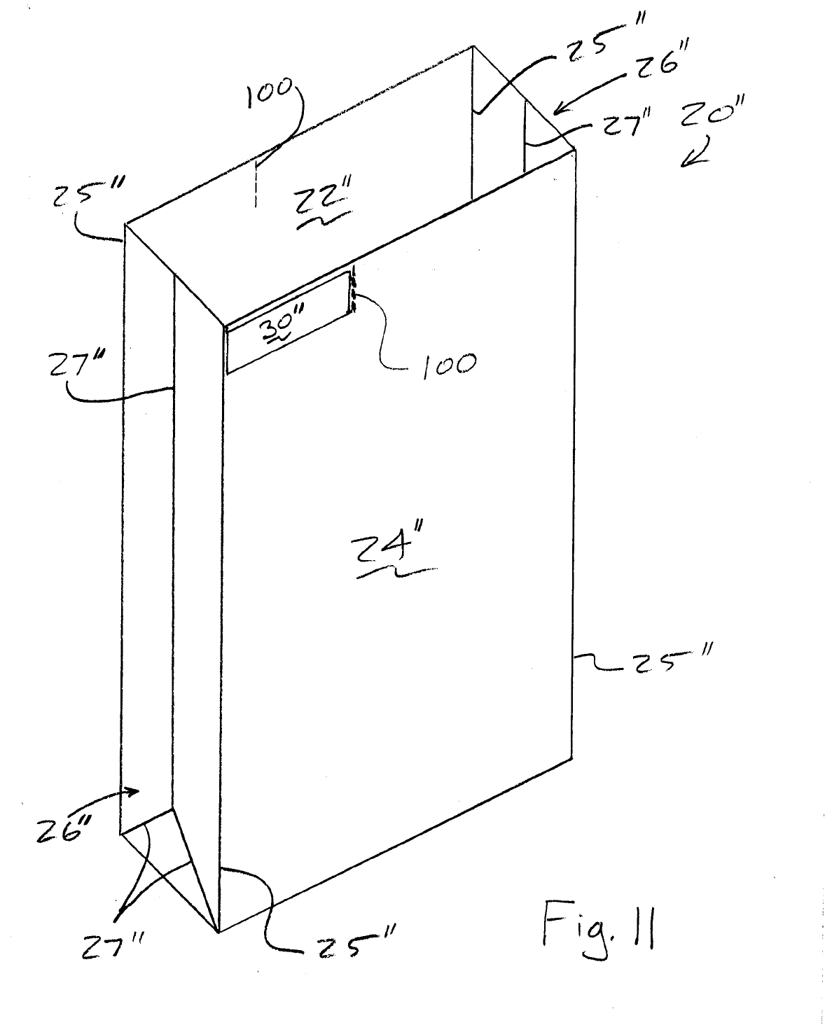

The container, or more specifically the bag 20″, of the fourth embodiment is discussed in the following with reference to FIGS. 10-18. The bag 20″ is shown in FIGS. 10 and 11 with its upper end fully open, and its lower end closed. In the fourth embodiment, the front fastener part 28″ is a strip of looped material of the conventional hook-and-loop fastener, and the rear fastener part 30″ is a strip of hooked material of the conventional hook-and-loop fastener, although the strips of hooked and looped material may be interchanged. The strip-like front and rear fastener parts 28″, 30″ may extend laterally from adjacent the right side of the bag 20″ to about one third of the way across the front and rear walls 22″, 24″, respectively. A variety of different types, sizes and arrangements of the fastener parts 28″, 30″ are within the scope of this disclosure.

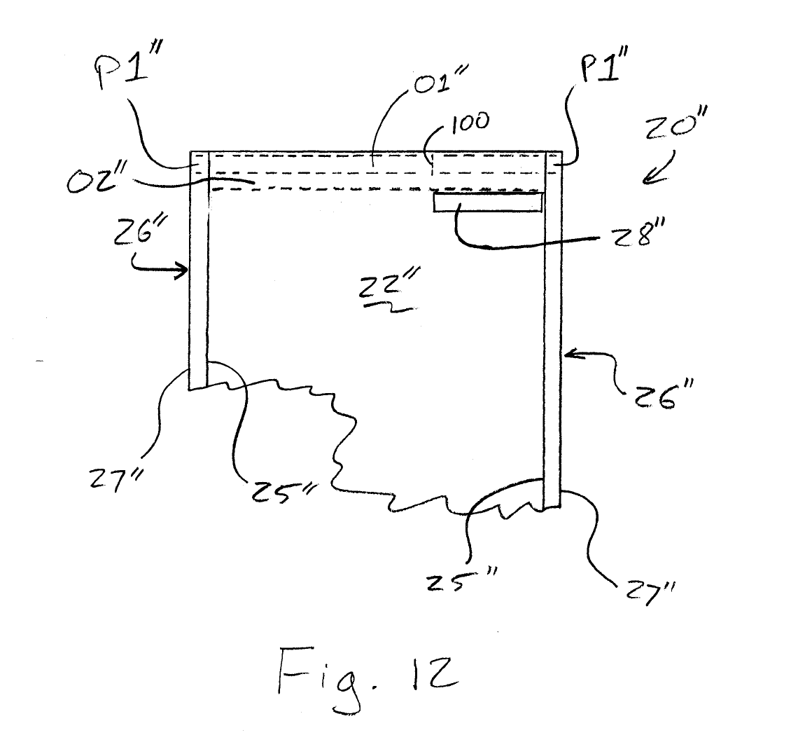

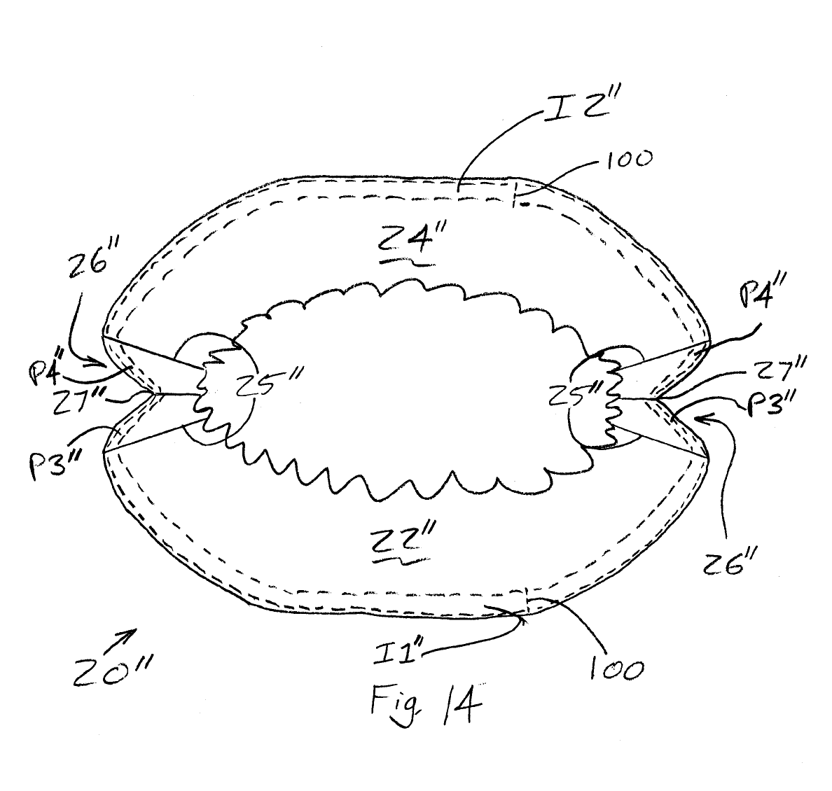

Optionally, disruptions 100 may be formed in the front and rear walls 22″, 24″ proximate the left ends of the front and rear fastener parts 28″, 30″, respectively. In the forth embodiment, the disruptions 100 are longitudinally extending lines of disruption (e.g., tear lines) that are positioned about one third, or a little more than a third, of the way across the front and rear walls 22″, 24″ from the right side of the bag 20″; and these tear lines respectively extend from closely adjacent the upper edges of the front and rear walls to closely adjacent the lower edges of the first portion O1″ (FIG. 12) and first inner portion I1″ (FIG. 14) of the front wall 22″, and closely adjacent the lower edge of the first inner portion I2″ (FIG. 14) of the rear wall 24″. In the fourth embodiment, the fastener parts 28″, 30″ are located slightly to the right of the disruptions 100. For example, the front fastener part 28″ is positioned between the longitudinal axis of the front line of disruption 100 and the right edge of the front wall 22″. As another example, the rear fastener part 30″ is positioned between the rear line of disruption 100 and the right edge of the rear wall 24″.

Any perforations, slits, or the like, of the disruptions 100 (e.g., tear lines) may be at least partially sealed closed, or substantially sealed closed, by adhesive material associated with the at least one seal (e.g., the pinch seal and/or the foldover seal) for maintaining the top of the bag 20″ in the single foldover configuration, as discussed in greater detail below. Accordingly, one or both of the disruptions 100 may optionally be a continuous cut line or slit. A variety of different types, sizes and arrangements disruptions 100 (e.g., tear lines) are within the scope of this disclosure. For example, each of the disruptions 100 may alternatively be tear starters that are in the form of single perforation or slit that may be immediate adjacent and extend to the upper edges of the front and rear walls 22″, 24″, respectively. As another example, one or more of the disruptions 100 may be omitted.

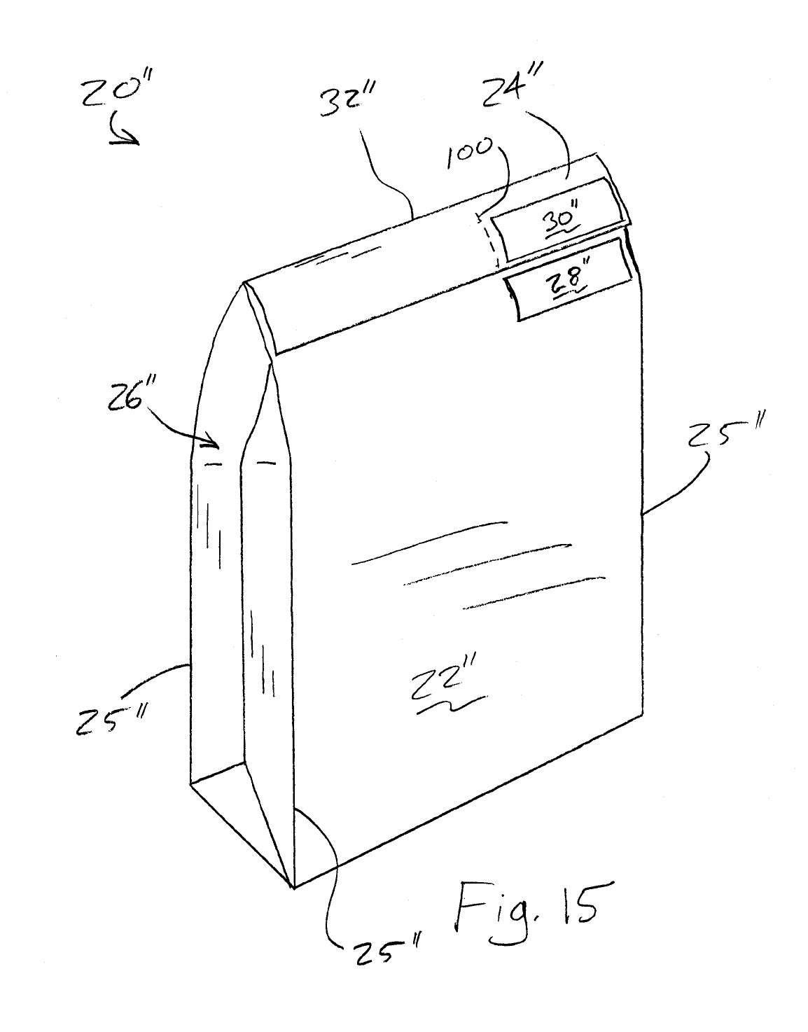

An example of a method of using the bag 20″ is described in the following, in accordance with the fourth embodiment. With the bottom of the bag 20″ fully formed/closed, contents are loaded into the interior of the bag 20″ through its substantially tubular upper opening. Then, and as shown in FIG. 15, the top of the bag 20″ is closed by a single foldover closure, and the single foldover closure is secured with at least one seal (e.g., hermetically sealed closed). The single foldover closure includes a first lateral line of disruption 32″ (e.g., fold line) about which both of the front and rear walls 22″, 24″ are simultaneously folded to transform the substantially tubular upper end of the bag 20″ into the single foldover configuration. In accordance with the fourth embodiment, the at least one seal typically comprises both a pinch seal and a foldover seal.

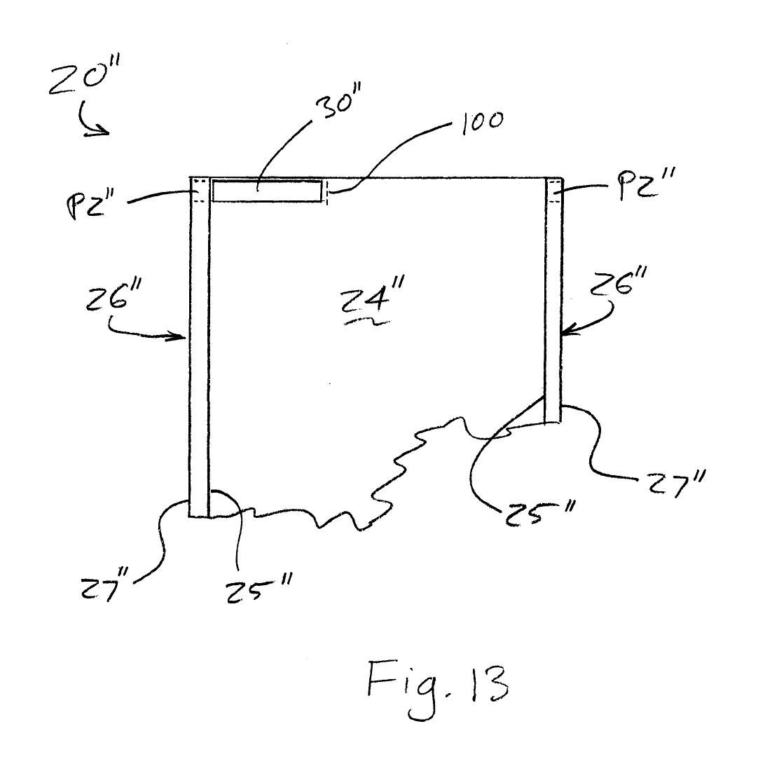

As best understood with reference to FIGS. 12-14, in the pinch seal:
all (e.g., substantially all) of the portions of the inner portions I1″, I2″ (FIG. 14) that are in opposing face-to-face relation with one another are in opposing face-to-face contact with one another and are sealed to one another;
at each side pleat 26″, all (e.g., substantially all) of the surface portions P1″, P2″ (FIGS. 12 and 13) are in opposing face-to-face contact with one another and are sealed to one another;
at each side pleat 26″, all (e.g., substantially all) of the surface portion P3″ (FIG. 14) and the inner portion I1″ are in opposing face-to-face contact with one another and are sealed to one another; and
at each side pleat 26″, all (e.g., substantially all) of the surface portion P4″ (FIG. 14) and the inner portion I2″ are in opposing face-to-face contact with one another and are sealed to one another.

In the foldover seal, all (e.g., substantially all) of the portions O1″, O2″ (FIG. 12) are in opposing face-to-face contact with one another and are sealed to one another. The at least one seal (e.g., the pinch seal and/or the foldover seal) for maintaining the top of the bag 20″ in the single foldover configuration may be provided in any suitable conventional manner, such as by way of a heat sealable material, adhesive material, mechanical fasteners, or otherwise. Similarly, the fastener parts 28″, 30″ may be fixedly connected to the front and rear walls 22, 24 of the bag in any suitable manner, such as by way of a heat sealable material, adhesive material, mechanical fasteners, or otherwise. Adhesive material may be intervened between above-mentioned portions that are referred to as being in opposing face-to-face contact; therefore, each of those opposing face-to-face contacts may be more generally referred to as substantially opposing face-to-face contact.

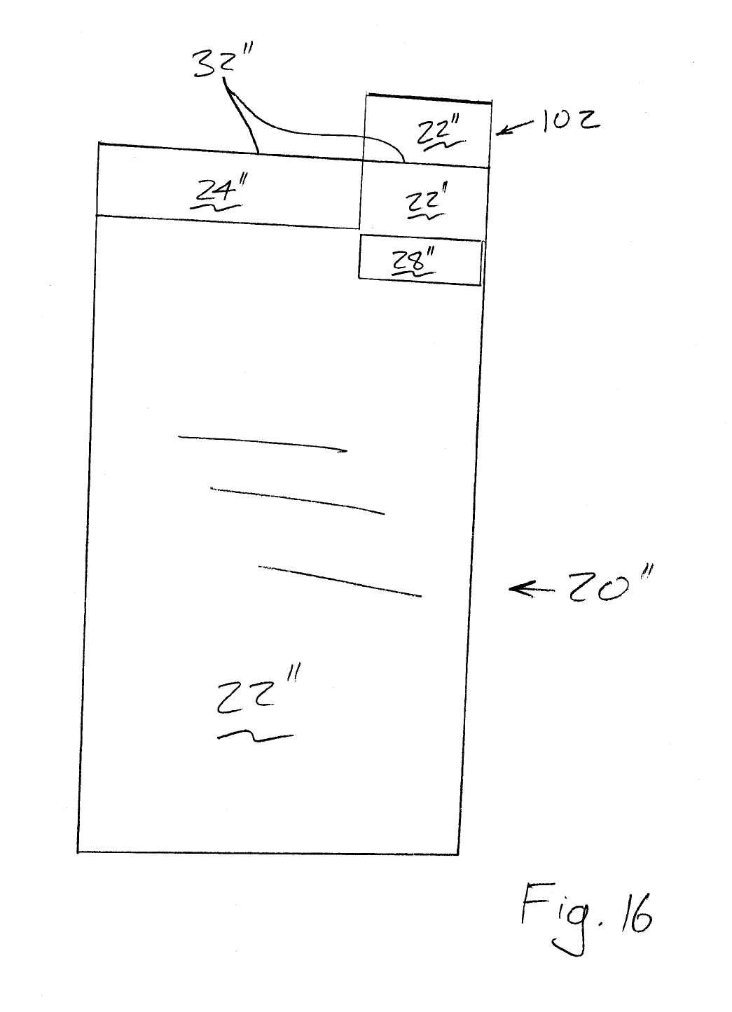

An example of a method of accessing the contents within the bag 20″ is described in the following, in accordance with the fourth embodiment. When it is desired to access the contents in the bag 20, the portion of the at least one seal that is located between the disruptions 100 and the right side of the bag 20″ is typically manually undone, which will include tearing along the disruptions 100 when they are in the form of tear lines. More specifically in accordance with one example of a method of the fourth embodiment, substantially simultaneously there is separation along the disruptions 100 (e.g., these tear lines are torn) and the portion of the foldover seal located between the disruptions 100 and the right side of the bag 20″ is manually undone by folding the right upper marginal portion 102 (FIG. 16) of the bag upwardly relative to the remainder of the bag, to transition from the fully closed, single foldover configuration shown in FIG. 15 to the partially open configuration shown in FIG. 16. In the fourth embodiment, the disruptions 100 are substantially aligned/superposed with one another while the top of the bag 20″ is closed by the single foldover closure and the single foldover closure is secured with the at least one seal (e.g., the pinch seal and/or the foldover seal). As best understood with reference to FIGS. 15-17, the disruptions 100 (e.g., tear lines) of the first embodiment extend from close proximity to the fold line 32″ to close proximity to the upper edges of the front and rear walls 22″, 24″, respectively, typically without the disruptions 100 (e.g., tear lines) extending across the fold line 32″, so that the tearing of (e.g., separating along) the disruptions 100 typically ceases at or proximate the fold line 32″. Alternatively, any other suitable disruptions 100 (e.g., tear lines), tearing, or the like, may be utilized.

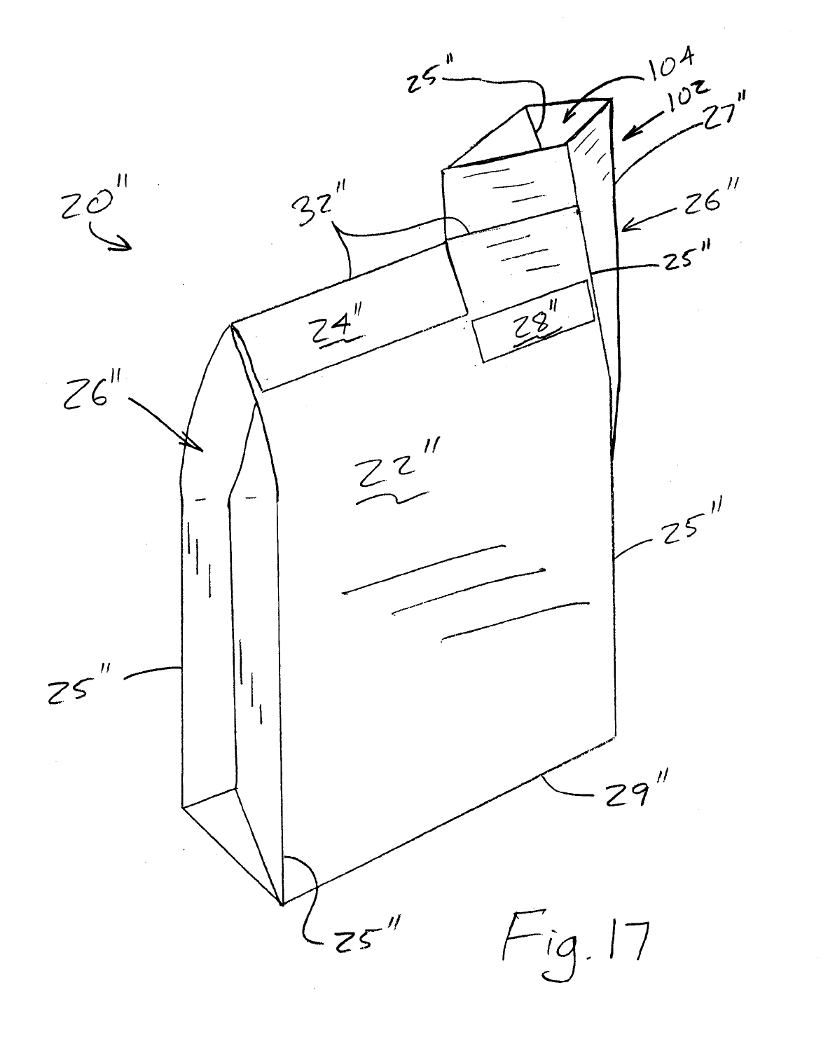

After the foldover seal is undone in the right upper marginal portion 102 of the bag 20″, the pinch seal is manually undone in the right upper marginal portion 102 of the bag 20″. As part of undoing the pinch seal in the right upper marginal portion 102 of the bag 20″, or after undoing the pinch seal in the right upper marginal portion, the upper portion of the right side pleat 26″ may be folded outwardly and the right upper marginal portion 102 may be configured as a pour spout defining a spout opening 104 that is open to the interior of the bag 20″, as shown in FIG. 17. Contents may be dispensed from the bag 20″ through the spout opening 104. In the forth embodiment, simultaneously with the pour spout/spout opening 104 being defined by the right upper marginal portion 102 of the bag 20″, the left upper marginal portion of the bag is at least partially closed, or more specifically the central and left upper marginal portions of the bag typically remain fully closed by an undisturbed portion of the sealed single foldover closure.

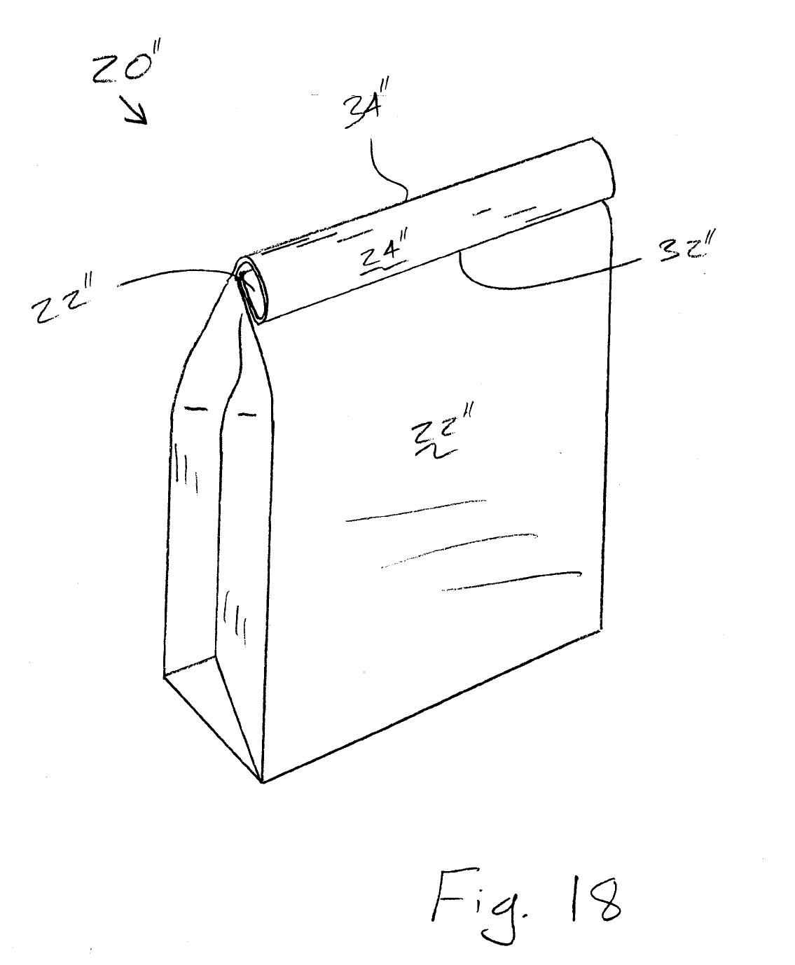

Thereafter, the pour spout/spout opening 104 may be closed by configuring the upper end of the bag 20″ in the double foldover configuration shown in FIG. 18. The bag may be releasably secured in the double foldover configuration by activating the reusable fastener (i.e., by manually pressing together the front and rear fastener parts 28″, 30″ so that they become releasably interlocked to one another). That is, as shown in FIG. 18, the bag 20″ is configured in the double foldover configuration, and the front and rear fastener parts 28″, 30″ are secured to one another (i.e., releasably interlocked to one another) so that the bag is releasably maintained in the double foldover configuration. The double foldover closure includes the first lateral line of disruption 32″ and a second lateral line of disruption 34″ (e.g., fold line). The double foldover configuration may be achieved from the spout configuration shown in FIG. 17 by first returning the right upper marginal portion 102 of the bag 20″ to the single foldover configuration (e.g., returning to the partially open configuration shown in FIG. 16, comprising folding the upper portion of the right side pleat 26″ inwardly; and then returning to the single foldover configuration shown in FIG. 15, comprising folding the right upper marginal portion 102/simultaneously folding the right upper marginal portions of the front and rear walls 22″, 24″ downwardly about the first lateral line of disruption 32″). Then, from the single foldover configuration shown in FIG. 15, the double foldover configuration shown in FIG. 18 may be achieved by simultaneously folding the front and rear walls 22″, 24″ about the second lateral line of disruption 34″, so that the rear fastener 30″ engages the front fastener 28″ to releasably secure the bag 20″ in its double foldover configuration shown in FIG. 18.

Thereafter, when it is desired to access the contents within the bag 20, the fastener parts 28, 30 may be manually separated from one another to deactivate the reusable fastener, and then the right upper marginal portion 102 of the bag 20″ may be opened/formed into the spout, for dispensing contents from the bag. The upper end of the bag 20″ may be conveniently transitioned numerous times between the spout configuration (e.g., see FIG. 17) and the configuration in which the bag is releasably secured in the double foldover configuration by the interlocked fastener parts 28″, 30″ (e.g., see FIG. 18). If desired, additional pairs of fastener parts (e.g., see front and rear fastener parts 28a, 28b, 30a, 30b, in FIG. 7) may be mounted to the bag 20″ for helping to releasably secure the bag in its double foldover configuration.

A fold line can be any substantially linear, although not necessarily straight, form of weakening that facilitates folding therealong. More specifically, but not for the purpose of narrowing the scope of the present disclosure, fold lines may include: a line of weakening formed by folding therealong and/or a score line, such as a line formed with a blunt scoring knife, or the like, which creates a crushed or depressed portion in the material along the desired line of weakness.

As an example, a tear line can include: a slit that extends partially into the material along the desired line of weakness, and/or a series of spaced apart slits that extend partially into and/or completely through the material along the desired line of weakness, or various combinations of these features. As a more specific example, one type tear line is in the form of a series of spaced apart slits that extend completely through the material, with adjacent slits being spaced apart slightly so that a nick (e.g., a small somewhat bridging-like piece of the material) is defined between the adjacent slits for typically temporarily connecting the material across the tear line. The nicks are broken during tearing along the tear line. The nicks typically are a relatively small percentage of the tear line, and alternatively the nicks can be omitted from or torn in a tear line such that the tear line is a continuous cut or torn line. That is, it is within the scope of the present disclosure for each of the tear lines to be replaced with a continuous torn line, a continuous cut line, a continuous slit, or the like. For example, a cut line may be a continuous slit or could be wider than a slit.

Directional references (e.g., upper, lower, upward, downward, left, right, leftward, rightward, top, bottom, above, below, vertical, horizontal, clockwise, and counterclockwise) have been used in this disclosure for ease of understanding and not for the purpose of limiting the scope of this disclosure. For example, the disruptions 100, spout and spout opening 104 may alternatively be formed in the left upper marginal portion of the bags, in which case the disruptions and fastener parts would be rearranged accordingly. In this regard, the right and left upper marginal portions of the bags may be more generally referred to as side upper marginal portions. As another example, the foldover closures may be formed by folding the top of the bag rearwardly rather than forwardly, in which case the fastener parts would be rearranged accordingly. Also, in considering the scope of this disclosure, each of the features of this disclosure may be considered in isolation, and in various combinations and subcombinations.

It will be understood by those skilled in the art that while the present disclosure has been discussed above with reference to exemplary embodiments, various additions, modifications and changes can be made thereto without departing from the spirit and scope of the invention as set forth in the claims.

What is claimed is:

1. A packaged product assembly, comprising:
a product comprising a particulate matter; and
a bag that contains the product, the bag comprising:
a first wall and a second wall connected by a plurality of side walls and a bottom wall, wherein the first wall, the second wall, and the side walls extend from the bottom wall to an upper end;
a reusable fastener comprising a first fastener part mounted to the first wall and a second fastener part mounted to the second wall,
wherein one of the first fastener part and the second fastener part comprises a hooked material and one of the first fastener part and the second fastener part comprises a looped material,
wherein the upper end is configurable between:
a first closed configuration wherein the first wall is secured to the second wall;
a second closed configuration wherein the first fastener part is fastened to the second fastener part; and
an at least partially open configuration wherein the first wall is at least partially separated from the second wall.

2. The packaged product assembly of claim 1, wherein in the first closed configuration the first wall and the second wall are folded at a lateral line of disruption.

3. The packaged product assembly of claim 2, wherein in the first closed configuration a first outer portion of the first wall is in opposing face-to-face contact with a second outer portion of the first wall.

4. The packaged product assembly of claim 2, wherein in the second closed configuration the first wall and the second wall are folded at the lateral line of disruption and at a second lateral line of disruption.

5. The packaged product assembly of claim 1, wherein in the at least partially open configuration a distance between the first fastener and the upper end is greater than a distance between the second fastener and the upper end.

6. The packaged product assembly of claim 1, wherein the product comprises a pet food.

7. The packaged product assembly of claim 1, wherein the first wall, the second wall, the side walls, and the bottom wall comprise at least one of a paper material and a polymer film.

8. A bag configured to contain a product, the bag comprising:
a first wall and a second wall connected by a plurality of side walls and a bottom wall, wherein the first wall, the second wall, and the side walls extend from the bottom wall to an upper end;
a reusable fastener comprising a first fastener part mounted to the first wall and a second fastener part mounted to the second wall,
wherein one of the first fastener part and the second fastener part comprises a hooked material and one of the first fastener part and the second fastener part comprises a looped material,
wherein the upper end is configurable between:
a first closed configuration wherein the first wall is secured to the second wall;
a second closed configuration wherein the first fastener part is fastened to the second fastener part; and
an at least partially open configuration wherein the first wall is at least partially separated from the second wall, and
wherein the first wall, the second wall, the side walls, and the bottom wall comprise a paper material.

9. The bag of claim 8, wherein the side walls comprise a plurality of side pleats formed by a plurality of lines of disruption.

10. The bag of claim 9, wherein the side pleats are folded inwardly in the first closed configuration.

11. The bag of claim 10, wherein the side pleats respectively comprise a plurality of outer portions, and
wherein the outer portions of the side pleats are respectively sealed to one another in the first closed configuration.

12. The bag of claim 10, wherein the side pleats respectively comprise a plurality of inner portions, and
wherein each of the inner portions is respectively sealed to one of the first wall and the second wall in the first closed configuration.

13. The bag of claim 8, wherein in the first closed configuration the first wall is secured to the second wall by a single use seal.

14. The bag of claim 8, wherein in the first closed configuration the first wall and the second wall are folded at a lateral line of disruption.

15. The bag of claim 14, wherein in the first closed configuration a first outer portion of the first wall is in opposing face-to-face contact with a second outer portion of the first wall.

16. The bag of claim 14, wherein in the second closed configuration the first wall and the second wall are folded at the lateral line of disruption and at a second lateral line of disruption.

17. The bag of claim 8, wherein in the at least partially open configuration a distance between the first fastener and the upper end is greater than a distance between the second fastener and the upper end.

18. The bag of claim 8, wherein the at least partially open configuration comprises a pour spout configuration.

19. The bag of claim 8, wherein the at least partially open configuration simultaneously comprises:
a pour spout defined by a first upper marginal portion of the bag; and
a second upper marginal portion of the bag being at least partially closed, wherein the first and second upper marginal portions of the bag are positioned at opposite sides of the bag.

20. The bag of claim 8, further comprising a disruption that is positioned in the first wall between opposite first and second side edges of the first wall, wherein the first fastener part is positioned between the disruption and the first edge of the first wall.

21. The bag of claim 8, wherein the disruption is a tear line extending from proximate an upper edge of the first side wall toward the bottom wall.

22. A method for forming a packaged product assembly, the method comprising;
having a bag comprising:
a first wall and a second wall connected by a plurality of side walls and a bottom wall, wherein the first wall, the second wall, and the side walls extend from the bottom wall to an upper end;
a reusable fastener comprising a first fastener part mounted to the first wall and a second fastener part mounted to the second wall,
wherein one of the first fastener part and the second fastener part comprises a hooked material and one of the first fastener part and the second fastener part comprises a looped material,
configuring the upper end in an at least partially open configuration wherein the first wall is at least partially separated from the second wall;
at least partially filling the bag with a product comprising a particulate matter;
configuring the upper end in a first closed configuration wherein the first wall is secured to the second wall; and
configuring the upper end to a second closed configuration wherein the first fastener part is fastened to the second fastener part.

23. The method of claim 22, wherein:
configuring the upper end to the first closed configuration comprises folding the first wall and the second wall at a lateral line of disruption; and
configuring the upper end to the second closed configuration comprises folding the first wall and the second wall at a second lateral line of disruption.

24. A method of using a packaged product assembly, the method comprising:
at least partially opening an upper end of a bag, comprising forming an opening in the upper end of the bag;
then dispensing product from the bag through the opening; and
then at least partially closing the opening, comprising folding the upper end of the bag into a double foldover configuration, and pressing together front and rear fastener parts of the bag to at least partially secure the upper end of the bag in the double foldover configuration, wherein
the bag comprises a first wall and a second wall connected by a plurality of side walls and a bottom wall,
the first wall, the second wall, and the side walls extend from the bottom wall to the upper end,
the first fastener part is mounted to the first wall, and
the second fastener part is mounted to the second wall.

25. The method of claim 24, wherein the opening in the upper end of the bag is a spout opening, and wherein the at least partially opening of the upper end of a bag comprises simultaneously:
forming a pour spout with a first upper marginal portion of the bag, wherein the pour spout defines the spout opening; and
maintaining a second upper marginal portion of the bag at least partially closed, wherein the first and second upper marginal portions of the bag are positioned at opposite sides of the bag.
